(19) United States
(12) Patent Application Publication
(10) Pub. No.: US 2007/0013600 A1
(43) Pub. Date: Jan. 18, 2007

(54) ANTENNA RADIATORS MADE FROM METALIZED PLASTIC, COMPOSITES, OR FABRICS

(75) Inventors: Jonathan L. Sullivan, Lincoln, NE (US); James Blake Winter, Lincoln, NE (US); Monty Rohde, Lincoln, NE (US)

Correspondence Address: HOLLAND & HART, LLP, P.O BOX 8749, DENVER, CO, 80201, US

(73) Assignee: Centurion Wireless Technologies, Inc., Lincoln, NE (US)

(21) Appl. No.: 11/456,384

(22) Filed: Jul. 10, 2006

Related U.S. Application Data
(60) Provisional application No. 60/699,196, filed on Jul. 14, 2005.

(51) Int. Cl. H01Q 1/40

(52) U.S. Cl. 343/873; 343/897

(57) ABSTRACT

An antenna having a radiating element comprising a metalized fabric is provided. The antenna including a radiating element with a feed connection attached to the radiating element. The radiating element being constructed from a metalized fabric including a core material and a metal material.

### RELATED APPLICATIONS AND PRIORITY

The present invention claims the benefit of U.S. Provisional Application 60/699,196, filed Jul. 14, 2005, titled ANTENNA RADIATORS MADE FROM METALIZED PLASTIC, COMPOSITES, OR FABRICS, which disclosure is incorporated herein as if set out in full.

### FIELD OF THE INVENTION

The present invention relates to antenna radiators and, more particularly to antenna radiators made from metalized plastic, composites, and/or fabrics.

### BACKGROUND OF THE INVENTION

Conventionally, antenna radiators are constructed a number of ways. One way of constructing the radiator includes installing a stamped metal radiator onto a plastic substrate. While the radiator works satisfactory, it is difficult to manufacture the stamped metal into a shape that is compatible with the housing of the wireless device. As wireless devices become smaller, the problems associated with stamped metal are becoming exacerbated.

Another method of constructing an antenna radiator includes a two-shot molding/selective plating technique. Using a two shot molding technique, a first non-platable plastic is molded into a shape with a first shot. A second shot of platable plastic is molded to the first shot of non-platable plastic. The second shot is molded in the antenna radiator design. Metal is then plated to the platable plastic. While two shot molding provides a good radiator with the desired shape, it can be appreciated that the tooling requirements for two shot molding makes the two shot molded antenna difficult and expensive to make. Moreover, the plating process is difficult to develop for high volumes of antennas.

Of course, other methods and materials can be used to construct antenna radiators, but the other methods and materials suffer similar and other drawbacks. Thus, it would be desirable to develop a lower-cost, easily shaped conducive material that can be used as an antenna radiator.

### SUMMARY OF THE INVENTION

The present invention provides an antenna having a radiating element comprising a metalized fabric. The antenna including a radiating element with a feed connection attached to the radiating element. The radiating element being constructed from a metalized fabric including a core material and a metal material.

The present invention further provides methods of making an antenna having a radiating element comprising a metalized fabric. The method including the steps of forming a fabric and providing a metal material in or on the fabric. The fabric with metal is shaped into a radiator. A power feed connector is attached to the shaped fabric to form the antenna.

The foregoing and other features, utilities and advantages of the invention will be apparent from the following more particular description of a preferred embodiment of the invention as illustrated in the accompanying drawings

### BRIEF DESCRIPTION OF THE DRAWINGS

The accompanying drawings, which are incorporated in and constitute a part of this specification, illustrate embodiments of the present invention, and together with the description, serve to explain the principles thereof. Like items in the drawings are referred to using the same numerical reference.

FIG. 1 illustrates an antenna radiator constructed in accordance with the present invention.

FIG. 2 is a cross sectional view of the radiating element of FIG. 1.

### DETAILED DESCRIPTION

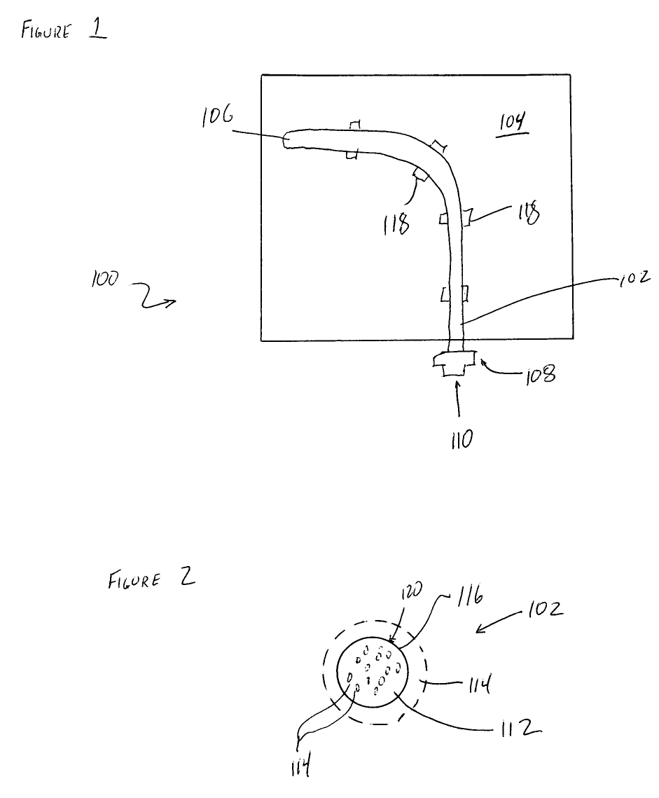

The present invention will now be described with reference to FIGS. 1 and 2. FIG. 1 shows an antenna structure 100. Antenna structure 100 is a dipole construction; however, one of ordinary skill in the art will recognize on reading the disclosure, other types of antenna structures are possible. Other antennas structures include, for example, monopole antennas, antenna arrays, PIFA antennas, microstrip antennas, transmission line antennas, patch antennas, meanderline antennas, whip antennas, retractable antennas, combinations thereof, or the like.

Antenna structure 100 is constructed as a dipole antenna and comprises a radiating element 102 mounted on a substrate 104. Substrate 104 is provided for support in the case of a dipole, but is optional. Substrate 104 may be removed if the material used to fabricate the antenna has sufficient rigidity for the application. Moreover, other forms of radiating structures would have the necessary components as known in the art and not re-described herein. Radiating element 102 has a free end 106 and a feed end 108. A power feed 110 is connected to feed end 108. In this case, power feed 110 is shown as a simple coaxial power feed connection, but any convention power feed type is possible. The radiating element 102 is shown as a dipole radiating element for convenience because dipole structures are relatively easy to illustrate and explain. One of ordinary skill in the art will recognize on reading the disclosure, however, that radiating element 102 could take many shapes as described above. For example, if antenna structure 100 was constructed as PIFA, radiating element 102 would be constructed as a planar element with a feed and short instead of a dipole element, etc.

Radiating element 102 comprises a core material 112 and a metal material 114. Core material 112 may be a composite, polymer, plastic, fabric, or foam material. Metal material 114 comprises a radiating material, such as, for example, copper, nickel, or the like. Metal material 114 needs to be sufficiently concentrated and uniform on a surface 116 of core material 112 such that radiating element 102 functions as a radiator. To accomplish this, radiating element 102 may be constructed in according with the following U.S. patents:
U.S. Pat. No. 4,910,072, titled SELECTIVE CATALYTIC ACTIVATION OF POLYMERIC FILMS, issued Mar. 20, 1990, to Morgan et al., and incorporated herein by reference as if set out in full.
U.S. Pat. No. 5,075,037, titled SELECTIVE CATALYTIC ACTIVATION OF POLYMERIC FILMS, issued Dec. 24, 1991, to Morgan et al., and incorporated herein by reference as if set out in full.
U.S. Pat. No. 5,082,734, titled CATALYTIC, WATER-SOLUBLE POLYMERIC FILMS FOR METAL COATINGS, issued Jan. 21, 1992, to Vaughn, and incorporated herein by reference as if set out in full.
U.S. Pat. No. 5,227,223, titled FABRICATING METAL ARTICLES FROM PRINTED IMAGES, issued Jul. 13, 1993, to Morgan et al., and incorporated herein by reference as if set out in full.
U.S. Pat. No. 5,328,750, titled FLEXIBLE PRINTED CIRCUITS, issued Jul. 12, 1994, to Morgan et al., and incorporated herein by reference as if set out in full.
U.S. Pat. No. 5,348,574, titled METAL-COATED POLYIMIDE, issued Sep. 20, 1994, to Tokas et al., and incorporated herein by reference as if set out in full.
U.S. Pat. No. 5,403,649, titled FABRICATING METAL ARTICLES FROM PRINTED IMAGES, issued Apr. 4, 1995, to Morgan et al., and incorporated herein by reference as if set out in full.
U.S. Pat. No. 5,437,916, titled FLEXIBLE PRINTED CIRCUITS, issued Aug. 1, 1995, to Morgan et al., and incorporated herein by reference as if set out in full.
U.S. Pat. No. 6,395,402, titled ELECTRICALLY CONDUCTIVE POLYMERIC FOAM AND METHOD OF PREPARATION THEREOF, issued May 28, 2002, to Lambert et al., and incorporate herein by reference as if set out in full.

As discussed in the '402 Patent, radiating element 102 may comprise a core material 112 with a surface coating of metal material 114, radiating element 102 may comprise a core material 112 impregnated with metal material 114, a combination thereof, or the like. Essentially, the requirement is radiating element 102 be sufficiently loaded with metal material 114 to act as an antenna radiator. In one exemplary embodiment, core material 112 is formed of a thread, such as, for example, polyester or nylon. The thread is formed into a fabric patch (1-8 oz./sq. yard) using conventional woven or non-woven technologies. The fabric thichness generally ranged from about 0.005 to 0.008, but can be much thinner or thicker depending on the particular application. The fabric is then dipped into a liquid catalyzed polymer 120 that acts as a seed layer between the polymer fibers and the metal layer. The metal is deposited on the fabric using conventional electroless or electrolytic processes. The liquid catalyzed polymers that acts as a seed to allow bonding between the fabric and the metal are generally known in the electroless and electrolytic arts. The metal may be, for example, nickel over copper with a copper thickness in the range of about 2 microns to about 15 microns.

To distinguish radiating element 102 from conventional stamped metal, plated metal, etch metal, or the like radiating elements, radiating element 102 may be generically referred to as a metalized fabric radiating element 102. The term fabric should be construed broadly, however, to include composites, polymers, polymeric films, plastics, foams, fabrics, and the like. Metalized fabric radiating element 102 is more easily formed into the necessary shape and volumes than conventional radiating elements. Metalized fabric radiating element 102 may be shaped and formed using conventional cutting technologies and methodologies, including, for example, die cut, laser cut, water jet cut, etc. Such cutting technologies and methodologies are generally know in the art and will not be further explained herein.

Once formed, metalized fabric radiating element 102 needs to be electrically and mechanically attached to the wireless device, not specifically shown. Electrically connecting metalized fabric radiating element 102 to the wireless device may include soldering, such as soldering connections 118 shown in FIG. 1 or by a non contacting method such as inductive coupling. Alternatively, metalized fabric radiating element 102 may be mechanically attached to the wireless device using insert molding, reel to reel molding, in-molding, or the like. Metalized fabric radiating element 102 may be mechanically attached to substrate 104 or other support structure, the outside of the wireless device, the inside of the wireless device, a separate component, or the like as a mater of design choice. Other possible ways to mount metalized fabric radiating antenna 102 are disclosed in U.S. Pat. No. 6,294,729, titled CLAD POLYMER EMI SHIELD, issued Sep. 25, 2001, to Kaplo. The '729 Patent is incorporated herein by reference as if set out in full. In some cases, metalized fabric radiating element 102 may be attached to a substrate, such as, for example, a printed circuit board, or the like, while in other cases, metalized fabric radiating element 102 may be free standing.

While the invention has been particularly shown and described with reference to an embodiment thereof, it will be understood by those skilled in the art that various other changes in the form and details may be made without departing from the spirit and scope of the invention.

1. An antenna, the antenna comprising:
a radiating element,
a feed connection attached to the radiating element; and
the radiating element comprising metalized fabric, the metalized fabric comprising a core material and a metal material.

2. The antenna according to claim 1, wherein the radiating element is formed into an antenna selected from the group of antenna consisting of: dipole antennas, monopoles antennas, loops antennas, planar antennas, microstrip antennas, helical antennas, meanderline antennas, or planar inverted F antennas.

3. The antenna according to claim 1, wherein the metal material is coated on an outer surface of the core material.

4. The antenna according to claim 1, wherein the metal material is embedded in the core material.

5. The antenna according to claim 3, wherein the metal material also is embedded in the core material.

6. The antenna according to claim 1, wherein the core material comprises a fabric formed from threads selected from the group of threads consisting of polyester threads or nylon threads.

7. The antenna according to claim 3, wherein the core material is coated with a seed material to allow the core material to bond to the metal material.

8. The antenna according to claim 7, wherein the seed material is a liquid catalyzed polymer.

9. The antenna according to claim 3, wherein the metal material is coated on the core material using an elecrtoless process.

10. The antenna according to claim 3, wherein the metal material is coated on the core material using an electrolytic process.

11. The antenna according to claim 1, wherein the metal material comprises copper.

12. The antenna according to claim 11, wherein the metal material further comprises nickel.

13. A method of forming an antenna having a metalized fabric radiator, the method comprising the steps of:
forming a fabric;
providing a metal material in or on the fabric;
shaping the fabric into a radiator; and
connecting a power feed connector to the shaped fabric.

14. The method according to claim 13, wherein the step of providing the metal material in or on the fabric comprises embedding metal material into the fabric.

15. The method according to claim 13, wherein the step of providing the metal material in or on the fabric comprises the step of coating the metal material onto the fabric.

16. The method according to claim 15, wherein the step of coating the metal material onto the fabric further includes coating a seed material on the fabric.

17. The method according to claim 13, wherein the step of forming a fabric comprises the step of forming a woven fabric comprising threads selected from the group of threads consisting of: polyester or nylon.

18. The method according to claim 13, wherein the step of forming a fabric comprises the step of forming a non-woven fabric comprising threads selected from the group of threads consisting of: polyester or nylon.
